(19) United States
(12) Patent Application Publication
(10) Pub. No.: US 2017/0214823 A1
(43) Pub. Date: Jul. 27, 2017

(54) COMPUTER SYSTEM FOR REFORMATTING INPUT FAX DATA INTO AN OUTPUT MARKUP LANGUAGE FORMAT

(71) Applicant: ZONCHI PTY LTD, Garibaldi (AU)

(72) Inventor: ROBERT MOOREHOUSE, Garibaldi (AU)

(73) Assignee: ZONCHI PTY LTD, Garibaldi (AU)

(21) Appl. No.: 15/417,093

(22) Filed: Jan. 26, 2017

(30) Foreign Application Priority Data
Jan. 27, 2016 (AU) 2016900230

(51) Int. Cl. H04N 1/32; H04N 1/00

(52) U.S. Cl. CPC H04N 1/32475; H04N 1/00206; H04N 1/00944; H04N 1/00915; H04N 1/00331; H04N 2201/3229; H04N 2201/3281; H04N 2201/0093

(57) ABSTRACT

There is provided a computer system for reformatting input fax data into output markup language format, the computer system comprising: a fax data interface; a database comprising a plurality of reformatting templates, wherein, in use, the system is configured for: receiving fax data via the fax data interface; selecting a reformatting template from the plurality of reformatting templates, the reformatting template comprising: metadata extraction template data; and output format template data; extracting metadata from the fax data in accordance with the metadata extraction template data; and generating the output markup language format in accordance with the output format template data and the meta data.

### FIELD OF THE INVENTION

The present invention relates to a system for fax data reformatting.

### BACKGROUND

Faxes are still widely used today in particular industries wherein, for example, in the medical industry, faxes are still used to send laboratory test results and the like to doctors and specialists.

These doctors and specialists usually employ full-time data entry staff to upload these faxes into clinical software applications.

For example, the Cabrini hospital in Melbourne alone sends approximately 70,000 faxes a year to doctors and specialists and, as can be appreciated, extensive man-hours are required for the manual processing and data entry of these faxes.

A need therefore exists for a system for receiving and reformatting these faxes into meta data markup format which may be then read by these clinical software applications.

It is to be understood that, if any prior art information is referred to herein, such reference does not constitute an admission that the information forms part of the common general knowledge in the art.

### SUMMARY OF THE DISCLOSURE

There is provided herein a system that reformats fax data into appropriate markup language (such as Hl7, C-CDA, CDA, EDIX12, EDIFACT, HIPAA, HL7, FHIR and ebXML) formats which may be read by clinical patient record management software and other software.

The system employs a metadata extraction technique which may utilise meta data extraction templates to control the extraction of the meta data from the fax data utilising various techniques including optical character recognition, region bounding, reading computer readable data (such 2D barcodes or the like).

Such meta data is then translated or compiled into the appropriate output format which may again utilise an output formatting template and wherein the template is selected in accordance with requirements of the computer endpoint.

The templates may be user configured or, in embodiments, controlled by the meta data itself wherein different templates are utilised depending on the content of the fax data.

The system also employs routing controls and triggers so as to route the output or trigger certain actions depending on the meta data extracted so as to allow for the intelligent automated processing of received faxes.

As such, with the foregoing in mind, in accordance with one aspect, there is provided A computer system for reformatting input fax data into output markup language format, the computer system comprising: a fax data interface; a database comprising a plurality of reformatting templates, wherein, in use, the system is configured for: Receiving fax data via the fax data interface; selecting a reformatting template from the plurality of reformatting templates, the reformatting template comprising: metadata extraction template data; and output format template data; extracting metadata from the fax data in accordance with the metadata extraction template data; and generating the output markup language format in accordance with the output format template data and the meta data.

The output markup language format may comprise at least one of C-CDA, CDA, EDIX12, EDIFACT, HIPAA, HL7, FHIR, PDF and ebXML formats.

The system may be configured for routing the output markup language format in accordance routing configuration metadata extracted from the metadata.

The routing configuration metadata may specify at least one endpoint destination.

The system may be configured for triggering an action in accordance with the metadata.

Triggering an action may comprise at least one of sending an electronic communication message and marking the output markup language format at prioritised.

The system may be configured for triggering an action by matching the metadata against trigger search strings.

The metadata may comprise action triggering instructions.

The fax data may comprise image data and wherein extracting metadata may comprise converting the image data to text using optical character recognition.

Extracting metadata may comprise region bounding to identify a subset of the text from a region of the image data.

Extracting metadata may comprise utilising text string matching.

The image data may comprise at least one image and wherein the system may be further configured for identifying the at least one image and wherein the output markup language may comprise an encoding of the at least one image.

The fax data may comprise computer readable data and wherein extracting metadata may comprise extracting at least some of the metadata from the computer readable data.

The computer readable data may comprise barcode data.

The barcode data may comprise 2D barcode data encoding the at least some of the metadata.

Selecting the reformatting template may comprise selecting the reformatting template in accordance with the metadata.

The system may further comprise encryption of the output markup language format using a public key associated with a private key of the endpoint computer.

The system may be configured for exposing an authentication secured API for authentication by the endpoint computer and the retrieval of the output markup language format.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a functional schematic of a fax data format reformatting receiver in accordance with an embodiment;

FIG. 2 shows an exemplary Internet server architecture for implementing the computer processes described herein in accordance with an embodiment;

FIG. 3 shows an exemplary model view controller (MVC) representation of the fax reformatting server of the system of FIG. 2 in accordance with an embodiment; and

FIG. 4 shows an exemplary illustrative method for fax data reformatting in accordance with an embodiment.

### DESCRIPTION OF EMBODIMENTS

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the structures, systems and associated methods relating to fax data format reformatting are disclosed and described, it is to be understood that this disclosure is not limited to the particular configurations, process steps, and materials disclosed herein as such may vary somewhat. It is also to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterised by,” and grammatical equivalents thereof are inclusive or open-ended terms that do not exclude additional, unrecited elements or method steps.

It should be noted in the following description that like or the same reference numerals in different embodiments denote the same or similar features.

### Functional Schematic

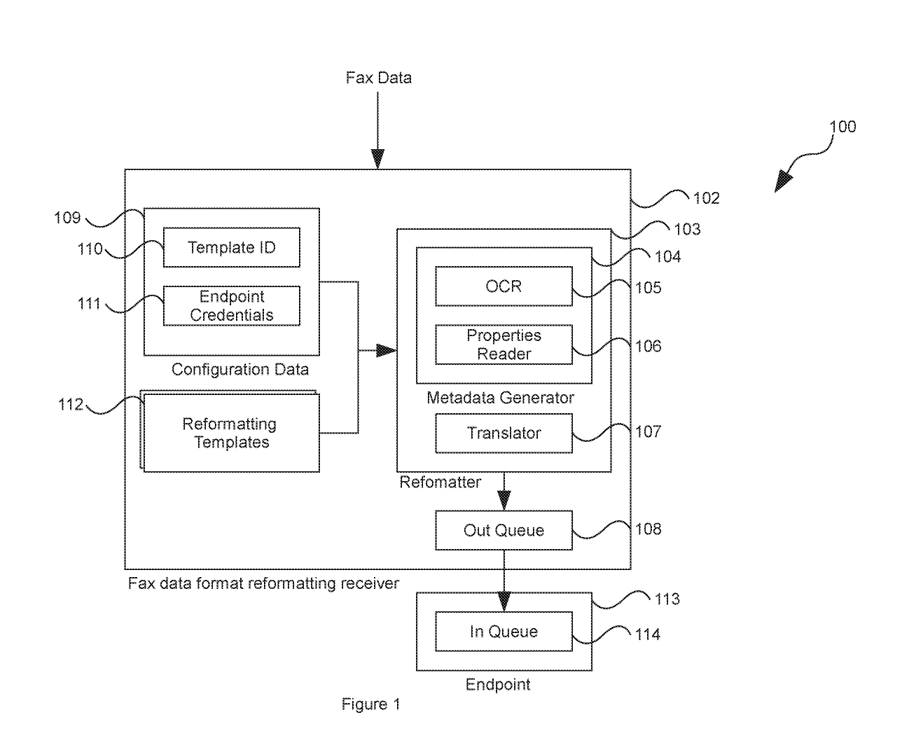

Turning now to FIG. 1, there is shown a functional schematic of a system 100 for reformatting fax data. As will be described in further detail below, the system 100 is configured for reformatting faxes for delivery to various endpoints so as to avoid conventional manual handling faxes such as physical receipt, scanning, uploading and the like.

For example, in particular embodiments as will be described in further detail below, the system 100 is configured for allowing received faxes to be reformatted and automatically uploaded into an appropriate software application endpoint.

For example, in one particular application, the system 100 may be utilised within the hospital environment. In this regard, doctors normally employ full-time staff to scan and upload faxes and letters into clinical software applications whereafter, once uploaded, the faxes and allocated to the appropriate patient. The Cabrini Hospital in Melbourne alone sends approximately 70,000 faxes a year to doctors and specialists so extensive man-hours are required for the manual processing of these faxes from this hospital alone.

As such, and with this particular application in mind, as will be seen from the ensuing description, the system 100 may be utilised by doctors, specialists and the like so as to allow for the automated processing of faxes wherein fax data is received, reformatted and automatically uploaded to the clinical software application. Of course, the embodiments described herein need not necessarily be utilised exclusively within the medical field and may have application for other applications utilising faxes such as, for example, for utilises an in other industries such as the finance, automotive industries or the like.

As will be described in further detail below, the system 100 is configured for reformatting input fax data into output markup language format. Specifically, the system comprises a fax data interface and a database comprising a plurality of reformatting templates.

As such, in use, the system is configured for receiving fax data via the fax data interface and selecting our reformatting template from the plurality of reformatting templates. In embodiment, the reformatting template may comprise meta data extraction template data controlling how the meta data is to be extracted and which meta data is to be kept. The reformatting template may further comprise output format template data specifying the output format and including how the extracted meta data is to be included in the format.

In this way, the system 100 is able to extract meta data from the fax data in accordance with the meta data extraction template data and then generate the output markup language format in accordance with the output format template data and the meta data.

Now, as can be seen, the system 100 comprises a fax data formatting receiver 102.

As will be described in further detail below, the formatting receiver 102 is primarily configured for the purposes of reformatting the fax data by performing various translations, Metadata identification/extraction and the like.

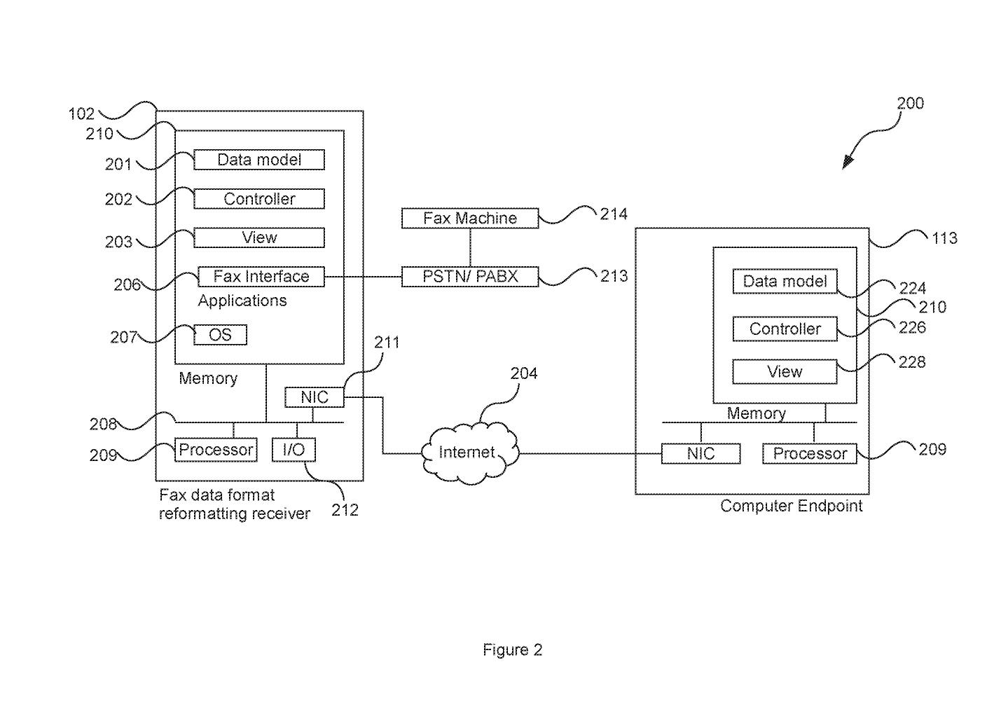

It should be noted that the reformatting receiver 102 may be implemented in differing technical manners depending on the particular application, including that which is illustrated in further detail in FIG. 2 and described in further detail below.

In one embodiment, the receiver 102 may be built into fax machines, multifunction printing devices and the like so as to implement the functionality described herein.

In this regard, these machines may be configured with the appropriate firmware, software and the like so as to and the functionality described herein.

In alternative embodiments, the functionality performed by the reformatting receiver 102 may be “cloud-based” wherein the functionality is performed by a remote computer server from which the reformatted fax data may then be retrieved. Such an embodiment is illustrated in FIG. 2, described in further detail below.

In further embodiments, the reformatting receiver 102 may be provided by way of software module executing on a client terminal, such as, for example, a medical practice computer or server executing patient medical record management software. In this regard, the software module executing on the medical practice computer or server may reformat inbound faxes into the appropriate format for utilisation by the patient medical record management software.

As can be seen from FIG. 1, the reformatting receiver 102 receives fax data and outputs the reformatted fax data to an end point 13. The endpoint 113 may be any appropriate recipient device, software application or the like capable of processing the reformatted fax data, such as the above described clinical software applications.

Now, the reformatting receiver 102 comprises a database comprising a plurality of reformatting templates 112.

At least one reformatting template 112 may be user selectable from the reformatting templates 112 so as to configure how the reformatting receiver 102 is to reformat the received fax data. In alternative embodiments, the receiver 102 may select the appropriate reformatting template 112 autonomously.

It should be noted that the reformatting templates 112 may be utilised for both controlling the meta data extraction from the fax data and also the reconstitution of the reformatted data as will be described in further detail below.

In embodiments, one template may be utilised to reformat all incoming faxes.

However, in other embodiments, the receiver 102 may be configured such that different templates are applied to faxes from different senders, such as which may be identified from the originating fax number. In this manner, only those faxes received from hospitals may be uploaded to the clinical software application.

Furthermore, the appropriate reformatting template 112 may be selected in accordance with the identified meta data itself wherein, for example, the meta data identified from the fax data (such as which may be ascertained via OCR described in further detail below) may identify the sender, subject of the fax or the like which is then utilised to decide on the appropriate template for reformatting.

For example, a fax comprising a patient health assessment report may be formatted differently to a fax comprising a prescription and therein the receiver 102 may decide on the appropriate reformatting template 112 to utilise.

The reformatting templates 112 may be configured by the user utilising the configuration data 109. As can be seen, the configuration data 109 may comprise the template ID 110 representing the reformatting template 112. Further configuration data may be employed to configure the reformatting template.

In embodiments, the reformatting receiver 102 may be provided with fax data reformatting templates 112 for popular or commonplace endpoint 113 devices or software applications. For example, a fax data reformatting template may be provided for the Zedmed clinical software application. In embodiment, the users may configure templates which may be shared with other users, such as templates defined in XML format.

As such, upon receipt of fax data, the reformatter 103 of the receiver 102 is configured for reformatting the fax data in accordance with the reformatting template 112 which has been selected by the user.

Different types of reformatting may be performed by the reformatter 103.

In embodiments, the reformatter 103 may perform image-based reformatting such as reformatting the fax data into image data format, such as JPEG data format.

In other embodiments the reformatter 103 may utilise optical character recognition (OCR) to reformat the fax data into text data.

However, in embodiments, the reformatter 103 may reformat the fax data into markup language formats. In this regard, the reformatter 103 may comprise a meta data generator 104 configured to identify and generate meta data for inclusion within the reformatted fax data and a translator 107 for translating the fax data into the meta data rich new format.

In the embodiment where the receiver 102 is utilised within the medical industry, the reformatter 103 may translate the fax data into HL7 message format.

Yet further, the fax data may be translated into other appropriate markup format including C-CDA, CDA, EDIX12, EDIFACT, HIPAA, HL7, FHIR and ebXML.

In further embodiments, other output formats may alternatively or additionally be utilised including human readable PDF format. Such PDF format documents may additionally encode the meta data.

There are different manners by which the meta data generator 104 may generate the metadata for inclusion in the reformatted fax data.

In one embodiment, the meta data generator 104 may utilise optical character recognition 5 to read portions of the fax, such as the sender name and/or number field, subject line, and the like for the purposes of generating the appropriate meta data. As alluded to above, such meta data may be utilised for selecting the appropriate template to utilise from the reformatting templates 112.

In embodiments, the reformatter 103 may be configured to use region bounding to identify text from on particular locations or regions of a fax page.

The reformatter 103 may utilise search strings to extract the meta data.

Meta data may be generated in other manners, such as by utilising the properties reader 106 which may read alternative properties of the fax such as the sender number, date and time received and the like.

In further embodiments, the meta data may be read from computer readable data. For example, a fax may be provided with barcode data, such as 2D barcode data (which may be affixed by way of a sticker or the like to the fact prior to sending) which may then be rendered via the meta data generator 104. For example, the 2D barcode data may comprise patient identification data or the like.

In embodiments, the meta data generator 104 may extract certain meta data from the computer readable data and other meta data utilising OCR.

In embodiments, the receiver 102 may be configured as to how to send the reformatted fax data in the output format to the endpoint 113. Such configuration may be configured utilising the endpoint credentials 111 of the configuration data 109.

For example, in embodiments, the receiver 102 may be configured to forward the reformatted fax data in the output format by email or the like to an appropriate endpoint 113 as is specified by an email address. The email account may be processed automatically by the endpoint 113 so as to remove received email messages comprising the reformatted fax data from the inbox for automatic uploading to the appropriate software application.

In other embodiments, the receiver 102 may be configured with authentication credentials or the like of the endpoint 113 so as to allow the receiver 102 to authenticate with the endpoint 113 (or vice versa) so as to upload the reformatted fax data appropriately.

In embodiments, the endpoint 113 may implement an in queue 14 to queue the incoming fax data for subsequent processing.

In embodiments, the reformatted fax data may be placed in an out queue 8 for retrieval upon demand. The output queue 8 is ideally suited for implementations where the receiver 102 is cloud-based so as to allow the endpoint devices and software application is 13 to periodically retrieve any queued fax data upon demand.

In embodiments, the meta data may be utilised for determining the sending of the reformatted fax data. For example, the recipient for the reformatted fax data may be identified from the meta data (such as which may be read utilising OCR, computer readable data or the like).

As such, a fax may be sent comprising details of the recipient endpoint 113, such as the IP address, email address or the like of the recipient endpoint such that, upon generating the reformatted fax data, the reformatted fax data may be sent (routed) appropriately according to the meta data.

In further embodiments, the reformatter receiver 102 may implement action triggers wherein, for example, certain meta data may trigger certain actions.

For example, blood test results may be processed in the normal manner wherein the reformatted fax data is sent to the appropriate endpoints (patient practice management software computers) of the relevant treatment doctors.

However, for blood test results faxes headed with the heading “urgent” or comprising abnormal results may be flagged or identified by the reformatting receiver 102 (such as by utilising string matching technique or the like) such that the reformatted text data may be sent or marked as priority or, in further embodiments, a notification communication may be additionally sent such as wherein, for example, an SMS notification may be sent to the treatment doctor informing the treatment doctor of the receipt of an important fax requiring immediate attention.

In further embodiments, additional communications may be sent to other parties wherein, for example, upon receipt of a fax comprising blood test results, the patient may be identified (such as by utilising OCR, computer readable data or the like) such that a communication (such as by way of SMS message) may be sent to the relevant patient so as to, for example, informing the patient of the receipt or completion of the blood test results than that the patient should book a consultation to review the results with the relevant treatment doctor.

In embodiments, the reformatted fax data in the output queue 8 may be encrypted so as to avoid unauthorised access. In this manner, upon retrieval from the output queue 8, the endpoint 113 would decrypt the encrypted reformatted fax data, such as by utilising a private key.

### Exemplary Computer Architecture

Turning now to FIG. 2, there is shown an exemplary computer architecture of a system 200 wherein the reformatting receiver 102 takes the form of a cloud-based server performing the computational processes described herein.

Specifically, as can be seen, the system 200 comprises the receiver server 102 which may take the form of a physical rack mounted server or virtualised server instance such as that which may be implement it by Amazon web services (AWS).

As can be further seen, the receiver server 102 may be in operable communication with a plurality of computer endpoints 113 across the Internet 204. In this way, the faxes reformatted by the receiver server 102 may be retrieved via the various computer endpoints 113 upon demand (such as via a web interface) or alternatively sent to the respective computer endpoints 113 utilising an email queue, API or the like.

The reformatting server 102 comprises a processor 209 for processing digital data.

The server 102 further comprises a memory device 210 for storing digital data including computer program code.

The memory device 210 is in operable communication with the processor 209 across system bus 208. In this manner, the processor 209 is able to fetch, decode and execute computer code instructions contained within the memory 210 including storing intermediate data results and data results therein.

In embodiments, the memory device 210 may take the form of one of a combination of volatile (such as RAM memory) and nonvolatile (such as HDD storage) memory.

The server 102 further comprises an I/O interface 212 for interfacing with various computer peripherals, including user interface devices and the like. In further embodiments, the I/O interface 210 may interface with data storage devices such as wherein, for example, a computer readable medium, such as a USB memory stick may comprise the computer code instructions for the implementation of the functionality herein and wherein the receiver server 102 may receive the computer code instructions from the memory device via the I/O interface 212.

The receiver server 102 may further comprise a network interface card 211 for sending and receiving data across the Internet 204.

As can be seen, the computer endpoints 113 may similarly comprise a network interface cards 211, processor 209 and memory devices 210.

Considering again the receiver server 102, as can be seen, the memory device 210 may be provided with a plurality of software modules for implementing the various computer processes described herein. Specifically, the memory device 210 may be configured with an operating system 207 such as the Linux kernel which is fetched by the processor 209 during the bootstrap phase.

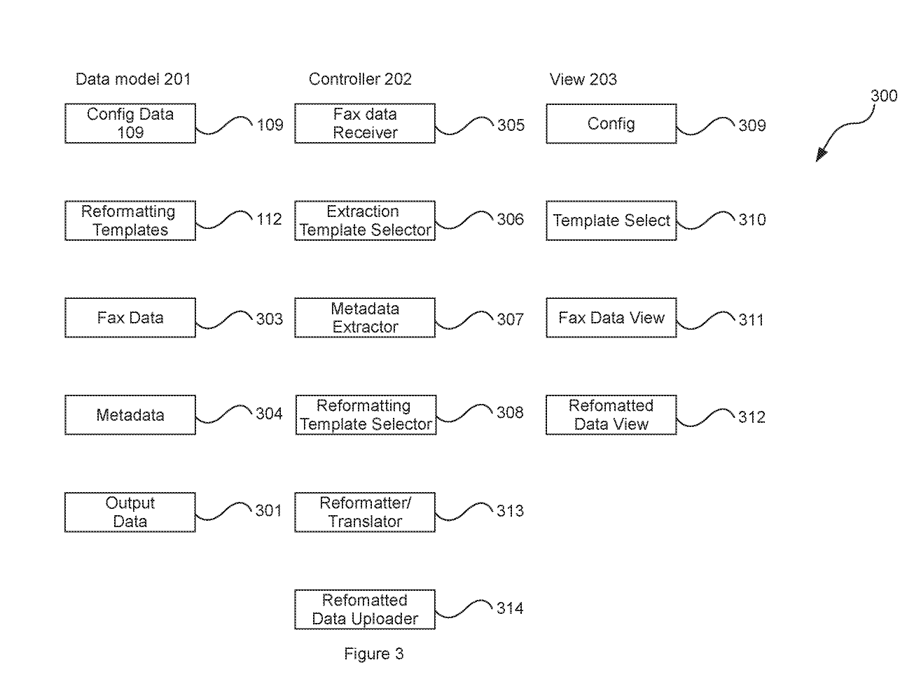

Furthermore, various custom software applications may be provided for implementing the various functionality herein wherein, for illustrative convenience, and as will be described in further detail below with reference to FIG. 3, the various software applications may comprise a data model 201, controller 202 and view 203 software applications.

In general terms, the data model 201 represents the data structure and the data stored therein. Furthermore, the view 203 manages the various user interfaces. Furthermore, the controller 202 implements the various computer processing tasks described herein including in interfacing the user interfaces and underlying data within the data model 201.

The software applications may further comprise a fax interface application 206 configured to receive the fax data from a telephone network 213, such as PSTN network, PABX system or the like so as to be able to receive the fax data from a fax machine 214.

It should be noted that the architecture of the system 200 is exemplary only and that no technical limitation should necessarily be imputed across the entire scope of the embodiments falling within the purposive scope of the present invention.

However, for the particular system 200 illustrated, in practice, and wherein the system 200 is utilised in the medical field, the computer endpoint 113 may represent a practice computer or server executing medical software controlling patient records.

The system 200 may be configured such that the receiver server 102 is configured to receive faxes via the telephone network 213 so as to perform the relevant transformations described herein including performing OCR of the fax data, identifying text data within specific regions of the facts, extracting relevant meta data and translating or reconstituting the output data (such as in XML format).

Then, at periodic intervals, the medical software application executing on a computer endpoint 113 may retrieve the XML data from the receiver server 102 which may then be entered into the medical software database.

For example, a particular fax may represent the blood test results for a patient wherein, upon receipt, the receiver server 102 may perform OCR on the fax data so as to identify the text “bloodwork results” or the like.

Having identified the relevant text string in this manner, the receiver server 102 may then select the appropriate reformatting template 112 to utilise.

Furthermore, wherein differing pathology providers may provide differing test result in differing formats, the receiver server 102 may further identify the sending fax number so as to identify the particular pathology provider so as to be able to further select an appropriate template for the bloodwork result format for the particular provider.

Thereafter, having selected the appropriate reformatting template 112, the receiver server 102 is able to extract the relevant meta data such as wherein, for example, the server 102 is able to search within the text at the top left-hand side of the fax to extract the patient name, patient address and the like and further extract the explanatory paragraph of text from midway down the fax page.

Such data may then be translated or reconstituted into the output markup language format which is then retrieved by the computer endpoint 113 for automatic inclusion within the patient record practice management software.

It should be noted that in addition to text extraction, the receiver server 102 may extract images, data tables and the like so as to be able to capture fax data represented in this manner such as x-ray images, charts and the like.

As such, when viewing the relevant patient record, the clinician or doctor is able to view the relevant results from within the patient record practice management software.

In embodiments, an image of the original fax may be stored within the memory 210 of the receiver server 102 or within the patient record practice management software for retrieval upon demand if required.

### Model View Controller

Turning now to FIG. 3, there is shown an exemplary model view controller (MVC) 300 representation of the software applications of the receiver server 102.

As is illustrated, the various software modules are divided for illustrative purposes into the data model 201, controller 202 and view 203.

As alluded to above, the data model 201 generally represents the data structure and the data stored therein (such as the relational database structure), the view 203 representing the various user interfaces and the controller 202 interfacing the user interfaces and the underlying data model 201.

Again, the exemplary MVC 300 is provided primarily for illustrative purposes to illustrate the various processes of the system and therefore that no technical limitation should necessarily be imputed to all embodiments within the purposive scope of the present invention.

As can be seen, the controller 202 may comprise a fax data receiver 305 which is configured for receiving the fax data, including via the telephone network 213. The fax data is receiver 305 may store the fax data within the fax data 303 of the data model 201. Such fax data 303 may be stored and image format, such as .tiff format.

The controller 202 may further comprise an extraction template selected 306 which is configured for selecting the appropriate reformatting template 112 from the data model 201.

As alluded to above, the extraction template may be selected in accordance with meta data, including meta data extracted from the fax data and the meta data identified from the associated fax data information, such as the sender fax number.

The controller 202 may further comprise a meta data extractor 307 which is configured for extracting the meta data (such as text and, in embodiments, image data) from the fax data.

The meta data extractor 307 may be configured in accordance with configuration data 109 which may configure the meta data extracted, the search strings utilised, the page locations for identification and the like.

The meta data extracted by the meta data extractor 307 may be stored within the meta data 304 of the data model 201.

The controller 202 may further comprise a reformatting template selector 308 configured to select an appropriate template for reformatting or translating the extracted meta data into an appropriate format, such as XML format, including HL7, C-CDA, CDA, EDIX12, EDIFACT, HIPAA, HL7, FHIR and ebXML formats.

It should be noted that, in embodiments, separate templates need not necessarily be utilised for extraction and reformatting, translating wherein a single template may control both. As alluded to above, the templates may be defined in markup language, such as XML format specifying various settings for the extraction of the markup language including search strings, page search locations and the like and various settings for the reformatting, translating into the output format such as the output format template comprising variable placeholders for the extracted meta data.

The controller 202 may further comprise the reformatter/translator 313 which performs the completion of the output data comprising the extracted meta data in accordance with the reformatting template 112.

The controller 202 may further comprise a reformatted data upload 314 which is configured to upload the reformatted data (such as in XML, format) to the appropriate endpoint 113.

Such output markup language format may be stored within the output data 301 of the data model.

Considering now the view 203, the view 203 may comprise a configuration interface 309 which may be utilised for inputting various configuration data including template controlling configuration data in the manner described herein.

Furthermore, the view 203 may comprise a template selection interface 310 allowing users to select the appropriate templates to utilise including the parameters for the selection of the appropriate template.

Furthermore, the view may comprise a fax data viewing interface 311 and a reformatted data viewing interface 312 for respectively viewing the raw input fax data and the reformatted/translated output data.

### Exemplary Method

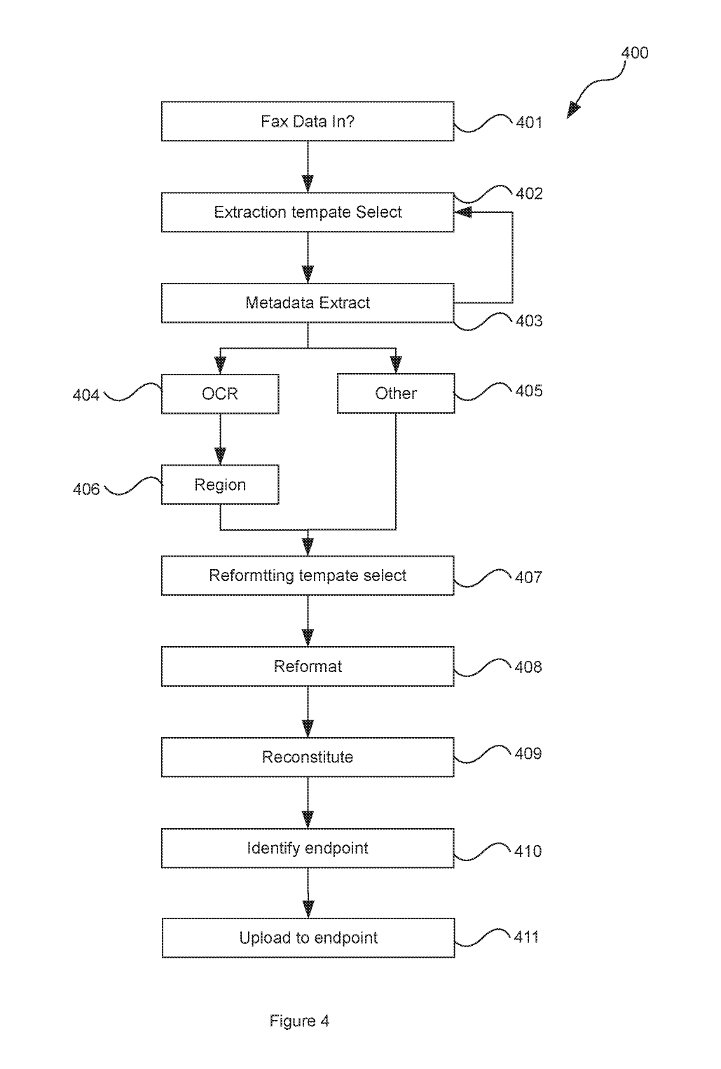

Turning now to FIG. 4, there is shown an exemplary method 400 for reformatting input fax data into output markup language format.

Again, it should be noted that the method 400 is exemplary only and that no technical limitations should necessarily be imputed to all embodiments accordingly.

Furthermore, for the exemplary method 400, it will be assumed that the system 200 takes the form of the system architecture as is substantially provided in FIG. 2 wherein the reformatting server 102 takes the form of an Internet-based server performing the fax data reformatting tasks which may then be provided to computer endpoints 113. In this regard, the exemplary method 400 illustrates the steps performed by the receiver server 102.

However, as alluded to above, other implementations are applicable wherein, for example, the functionality performed to herein may be performed by way of software or firmware executing on a fax receiver device, endpoint computer 113 or the like..

The method 400 starts at step 401 wherein the fax interface 206 is queried for received fax data.

Specifically, the receiver server 102 may be provided with a fax data in queue in which fax data is placed upon receipt which is periodically inspected for processing. As alluded to above, the fax data may be stored within the queue in image format, such as in .tiff format.

In this illustrative method 400 a pathology laboratory has sent a fax comprising blood test results relating to a patient to the patient's doctor. In this regard, the patient's doctor has configured the system 200 such that faxes received are sent to the server 102 for processing. In one embodiment, the system 200 is configured such that the fax data is transmitted directly to the server 102 via the telephony network 213.

In alternative embodiments, the doctor may utilise a fax receiver wherein the fax receiver is configured to forward (such as an image format) received fax data to the receiver server 102 for processing.

As alluded to above, in embodiments, the fax receiver may be configured for selective processing of faxes wherein, for example, only certain faxes forwarded to the receiver server 102 for processing such as which may be identified from associated meta data of the fax data such as the transmitting fax number.

As such, at step 402, the server 102 selects the appropriate extraction template to utilise for the meta data extraction at step 403.

It should be noted that the meta data extracted at the meta data extraction step 403 may be utilised for the selection of the appropriate extraction template 402.

Specific, the receiver server 102 may initially convert the entire fax image to text utilising OCR and then utilised keyword searching to identify keywords or phrases within the extracted text.

For example, the configuration data 109 may comprise the keyword search string “blood test results” wherein, if such a match is found, the server 102 is able to select the appropriate reformatting template 112 for such a format of fax.

In embodiments, the receiver server 102 may perform further filtering for appropriate template 112 selection wherein, for example, the receiver server 102 may further inspect the transmitting fax number so as to be able to identify the particular pathology laboratory so as to be able to utilise an appropriate reformatting template 112 for that particular laboratory as opposed to others.

It should be noted that other meta data may be utilised for the selection of appropriate templates.

Then, for the meta data extraction 403, as alluded to above, the meta data extraction 403 may utilise optical character recognition (OCR) at step 404 for the purposes of extracting meta data from the fax image data.

The text utilised for meta data extraction may be extracted from various regions of the fax image at step 406.

For example, the patient identification meta data may be extracted from the top left-hand side of the fax data wherein the test results may be extracted from the middle of the fax image and wherein the laboratory technician identification meta data may be extracted from the end of the fax image.

For extracting the meta data, string searching techniques may be utilised wherein, for example, text is extracted following appropriate string labels such as “patient name”, “patient address”.

Additional meta data may be recorded at step 405 over and above that which is extracted from the fax image data such as associated meta data such as the sending fax number.

Additionally, at least a subset of the meta data may be retrieved from computer readable data within the fax image encoding such meta data wherein, for example, a 2D barcode may encoded the patient identification meta data.

The extracted meta data may be stored within the data model 102.

Then, at step 407, the appropriate reformatting/translating template is selected. The reformatting template specifies how the extracted meta data is to be reconstituted into the appropriate output data structure such as in XML format so as to be computer readable at the appropriate endpoint 113.

For example, the reformatting template data may be selected in accordance with the type of endpoint 113 wherein, for example, the patient's doctor in this case runs a particular version of patient record practice management software and therein the reformatting template is selected at step 407 so as to reconstitute the meta data into the appropriate XML data readable by the particular type of patient record practice management software, including Hl7, C-CDA, CDA, EDIX12, EDIFACT, HIPAA, HL7, FHIR and ebXML formats.

As step 409, the markup data is reconstituted/translated into the output format utilising the appropriate reformatting template selected at step 407.

The reconstituted data may be stored within the data model 102 for retrieval upon demand by the appropriate endpoint 113.

However, in the embodiments shown, the method may entail identifying the appropriate endpoint at step 410 and then, at step 411, uploading the reformatted data to the endpoint 113 such as by utilising an API.

In embodiments, the method may entail encrypting the reformatted data. In one embodiment, the reformatted data may be encoded utilising a public key associated with a private key of a particular endpoint 113.

In embodiments, the reformatted data may be sent in a manner and to a specific endpoint 113 in accordance with the meta data.

Specifically, the meta data may identify the endpoint, such as a recipient IP address, API URL, email address or the like. As such, the reformatted data may be transmitted accordingly.

Additionally, the meta data may specify certain trigger actions. Specifically, the reformatting server 102 may be configured to identify certain meta data, such as wherein, for example, a fax is headed with a string of text comprising the word “urgent”. In this way, the output data may be marked as high priority or alternatively, a communication message may be sent to the appropriate treatment doctor, such as by way of SMS or the like informing the doctor of the receipt of an important fax document.

In alternative embodiments, as opposed to utilising string matching for firing the triggers, the action may be encoded within the meta data.

For example, a 2D barcode may be encoded with instructions as to the handling of the encoded data wherein, for example, the 2D barcode may encode message transmission instructions instructing the reformatting server 102 to email the reformatted dated to an email address associated with the treatment doctor and to furthermore send an SMS to a mobile number (also encoded within the 2D barcode data) to the patient informing the patient of the receipt of the test results.

### Interpretation

### Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes:

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means For Carrying out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention.

For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the fax transmission and processing systems industries.

1. A computer system for reformatting input fax data into an output markup language format, the computer system comprising:
a fax data interface;
a database comprising a plurality of reformatting templates, wherein, in use, the system is configured for:
receiving fax data via the fax data interface;
selecting a reformatting template from the plurality of reformatting templates, the reformatting template comprising:
metadata extraction template data; and
output format template data;
extracting metadata from the fax data in accordance with the metadata extraction template data; and
generating the output markup language format in accordance with the output format template data and the meta data.

2. A system as claimed in claim 1, wherein the output markup language format comprises at least one of C-CDA, CDA, EDIX12, EDIFACT, HIPAA, HL7, FHIR, PDF and ebXML formats.

3. A system as claimed in claim 1, wherein the system is configured for routing the output markup language format in accordance routing configuration metadata extracted from the metadata.

4. A system as claimed in claim 3, wherein the routing configuration metadata specifies at least one endpoint destination.

5. A system as claimed in claim 1, wherein the system is configured for triggering an action in accordance with the metadata.

6. A system as claimed in claim 5, wherein triggering an action comprises at least one of sending an electronic communication message and marking the output markup language format at prioritised.

7. A system as claimed in claim 5, wherein the system is configured for triggering an action by matching the metadata against trigger search strings.

8. A system as claimed in claim 5, wherein the metadata comprises action triggering instructions.

9. A system as claimed in claim 1, wherein the fax data comprises image data and wherein extracting metadata comprises converting the image data to text using optical character recognition.

10. A system as claimed in claim 9, wherein extracting metadata comprises region bounding to identify a subset of the text from a region of the image data.

11. A system as claimed in claim 9, wherein extracting metadata comprises utilising text string matching.

12. A system as claimed in claim 9, wherein the image data comprises at least one image and wherein the system is further configured for identifying the at least one image and wherein the output markup language comprises an encoding of the at least one image.

13. A system as claimed in claim 1, wherein the fax data comprises computer readable data and wherein extracting metadata comprises extracting at least some of the metadata from the computer readable data.

14. A system as claimed in claim 13, wherein the computer readable data comprises barcode data.

15. A system as claimed in claim 14, wherein the barcode data comprises 2D barcode data encoding the at least some of the metadata.

16. A system as claimed in claim 1, wherein selecting the reformatting template comprises selecting the reformatting template in accordance with the metadata.

17. A system as claimed in claim 1, further comprising encryption of the output markup language format using a public key associated with a private key of the endpoint computer.

18. A system as claimed in claim 1, wherein the system is configured for exposing an authentication secured API for authentication by the endpoint computer and the retrieval of the output markup language format.
